(19) United States
(12) Patent Application Publication
(10) Pub. No.: US 2025/0370914 A1
(43) Pub. Date: Dec. 4, 2025

(54) Testing Platform with Synchronized Application Specification Description

(71) Applicant: Conformiq Holding LLC, Saratoga, CA (US)

(72) Inventors: Mark Creamer, Saratoga, CA (US); Alexis Despeyroux, Paris (FR)

(21) Appl. No.: 18/731,083

(22) Filed: May 31, 2024

(51) Int. Cl. G06F 11/36

(52) U.S. Cl. CPC G06F 11/3684

(57) ABSTRACT

A computer-implemented method automatically generates a synchronized model based on a received text description and a synchronized text description based on a received model. The method comprises receiving application requirements input describing at least one desired application feature, the application requirements input comprising at least one of a model and a text description. A synchronized model is generated based on received text description. A synchronized text description is generated based on a received model. The synchronized model and synchronized text description both describe the same at least one desired application feature. In one embodiment, received test data is integrated with the synchronized model and the synchronized text description. At least one test is generated based on the synchronized model, the synchronized text description, and the integrated test data.

### TECHNICAL FIELD

The invention relates to testing solutions. Particularly, the present invention relates to solutions for testing software.

### Background

Testing applications are used to test software. For example, when software is developed, it may be beneficial to apply one or more tests to validate and verify that the developed software functions according to the expectations defined by the specification and/or the requirements before launch. Known solutions seem to be restricted to manual test case generation and/or automated test case generation that does not incorporate variables like data and automation frameworks.

Moreover, adequate testing requires a properly defined application specification. Legacy systems commonly require manual user input to describe the application specification, whether as a model or a text description. Deciding whether to use a model or a text description is a question of balancing advantages and disadvantages. In some cases, it is not practical to use both a model and a text description because of the additional effort required to produce an extra version of essentially the same application specification as well as the possibility of introducing error in the process of generating the additional version.

### BRIEF DESCRIPTION

According to an aspect, there is provided the subject matter of the independent claims. Some embodiments are defined in the dependent claims.

One or more examples of implementations are set forth in more detail in the accompanying drawings and the description below. Other features will be apparent from the description and drawings, and from the claims.

### BRIEF DESCRIPTION OF DRAWINGS

In the following embodiments will be described in greater detail with reference to the attached drawings, in which

FIG. 1 illustrates a software testing protocol to which the embodiments of the invention may be applied;

FIG. 2 illustrates an arrangement or a system for verifying test configuration;

FIG. 3 illustrates a signal diagram according to an embodiment;

FIG. 4 illustrates an exemplary system for generating application tests according to an embodiment;

FIGS. 5A-E illustrate a flow diagram according to an embodiment;

FIG. 6 illustrates a flow diagram according to an embodiment; and

FIGS. 7A-7B illustrate a time line of synchronized generation according to an embodiment.

### DETAILED DESCRIPTION OF SOME EMBODIMENTS

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. The embodiments are not restricted to the system given as an example but a person skilled in the art may apply the solution to other systems provided with necessary properties.

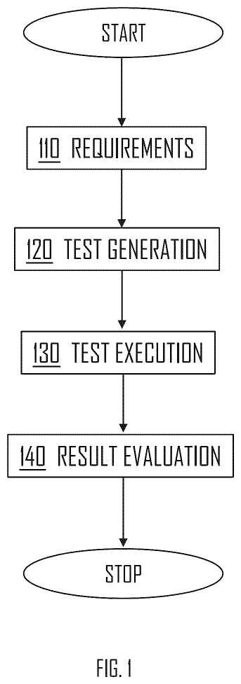

FIG. 1 illustrates an example diagram of software testing process to which the embodiments may be applied. Referring to FIG. 1, a testing process may comprise obtaining requirements for testing, the requirements being formal or informal (e.g., whiteboard markings, etc.) (block 110). Additionally, the testing requirements may be directed towards testing particular features of a software application that are specified in a model or text description. In many cases it is useful to have both a model and a text description, such as, for example, in cases in which one version is easier for a human user to read and another version is easier to configure in higher detail.

Based on the testing requirements, tests are generated (block 120). The generated tests are executed (block 130) to test a software application with tests that fulfill the testing requirements of block 110. The generated tests are executed in one way or another (e.g., automatic, partially automatic, or fully manually). Results are evaluated in block 140 based on the executed tests. The testing process may comprise jumping from one of the steps (110, 120, 130, 140) to a previous step: for example, after a failed test execution, amendments may be performed to the application, to the requirements, or to the generated tests (or artifacts from which the test are generated), and executed again. In another example, once the requirements change, the testing requirements are updated, new tests generated, the new tests executed, and results evaluated.

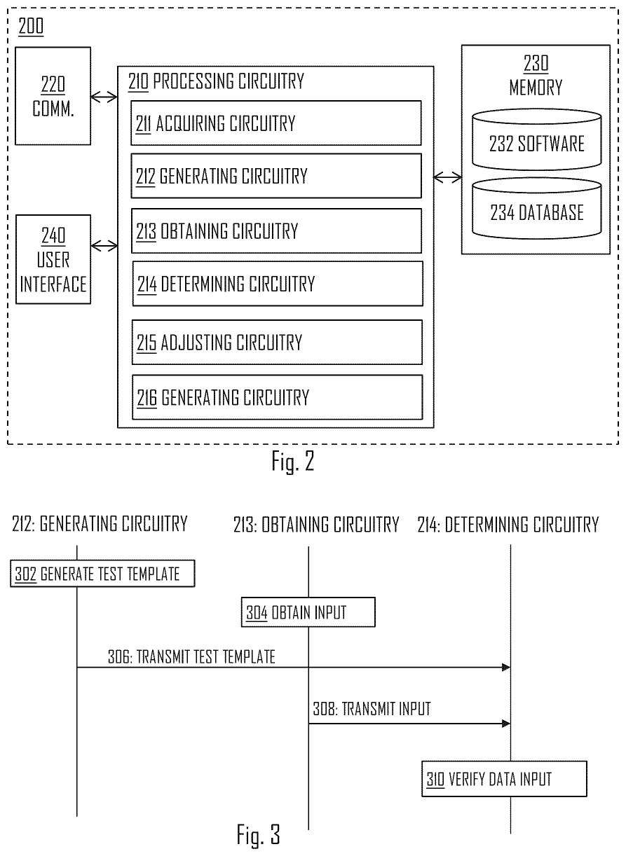

FIG. 2 illustrates an arrangement 200 for performing a method for developing software and embodiments thereof. The arrangement 200 may be partially or fully comprised in an apparatus, such as a computer (e.g., server computer), for example. According to an embodiment, the arrangement 200 carrying out the embodiments comprises a processing circuitry 210, including at least one processor, and at least one memory 230 including computer program code 232. When activated, the at least one processor and the at least one memory 230 causes the apparatus to perform at least some of the functionalities according to any one of the embodiments.

The arrangement 200 may comprise a communication circuitry 220 for wired and/or wireless communication. For example, the communication circuitry 220 may be used to obtain software application models from an external source, for example. For example, the memory 230 may comprise a database 234 for storing models. The database 234 may be external or part of the arrangement 200.

The arrangement 200 may comprise a user interface 240 for inputting data to and/or outputting data from the arrangement 200. For example, the user interface 240 may be used to input the models, by the user, to the arrangement 200. On the other hand, the user interface 240 may be used to enable the user to input and/or adjust data values of the test template (e.g., data input fields). The user interface 240 may include keyboard(s), microphone(s), display(s), pointer(s) (e.g., mouse), and the like. The user interface 240 may enable different kinds of interaction possibilities. For example, as described in more detail below, data values can be read/extracted from numerous sources: they can be inputted by the user (even in ad hoc fashion for experimentation), they can be collected from test data databases, from bug tracking systems, from explicit data design efforts, from data provisioning/management tools and databases, etc. The User Interface 240 (UI) may thus refer to capability to deal with such sources and/or targets.

According to an embodiment, the processing circuitry 210 comprises at least one of circuitries 211, 212, 213, 214, 215, and 216. In one embodiment, the acquiring circuitry 211 may be configured at least to perform operations of acquiring a model of a software application. The generating circuitry 212 may be configured at least to perform operations of generating test templates for testing functions of a software application. The obtaining circuitry 213 may be configured at least to perform operations of obtaining user input regarding a data input field of the testing template. The determining circuitry 214 may be configured at least to perform operations of determining whether input data conforms to constraints. The adjusting circuitry 215 may be configured at least to perform operations of adjusting data values to conform to constraints. The generating circuitry 216 may be configured at least to perform operations of generating software tests, particularly software tests based on a test template that conform to constraints.

It is also noted that the arrangement 200 may, according to an embodiment, be at least partially realized as a virtual arrangement running on physical resources, that is, a logical entity for which resources are provided by a plurality of distributed entities. For example, the functionalities of the arrangement 200 may be realized by one or more virtual machines running on one or more physical computers. Such arrangement may provide an even more flexible operating environment.

In one example, the test template or templates is a generated software program that encodes test scenarios and embeds an engine for testing data refinements (e.g., user input). As described in more detail below, certain aspects of the software development process, including each test template, may have a user interface for allowing the user to make said refinements to data values and other changes to the testing functions and/or the software application model or other related functions. Refinements may refer to the user input and/or selection regarding one or more data input fields and/or text or graphical descriptions of the application under consideration. Among other functions as described in more detail below, the refinements may be then verified and validate by said engine (i.e., data constraints are verified to be met). Further, each data or other refinement may have an impact on other data values in the given test scenario and/or on the application descriptions, and said engine may propagate the effect of data or other refinement in order to maintain the consistency of tests and/or the application model. In one embodiment, said test template may be configured to reject invalid data refinements, accept valid refinements, and export concrete test cases with valid data values.

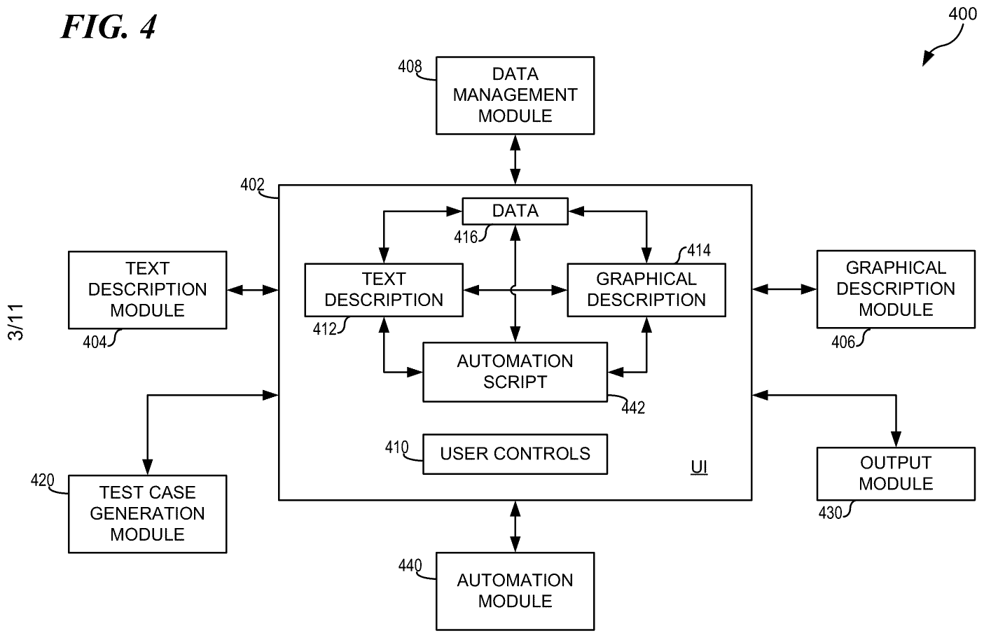

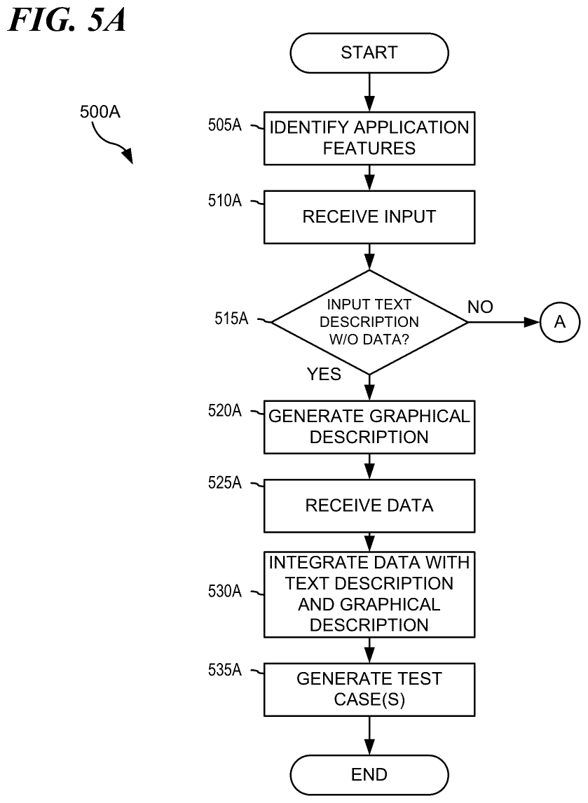

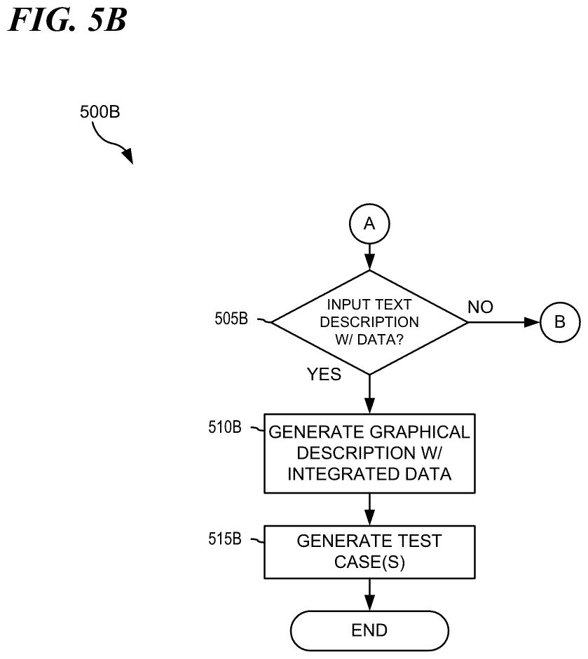

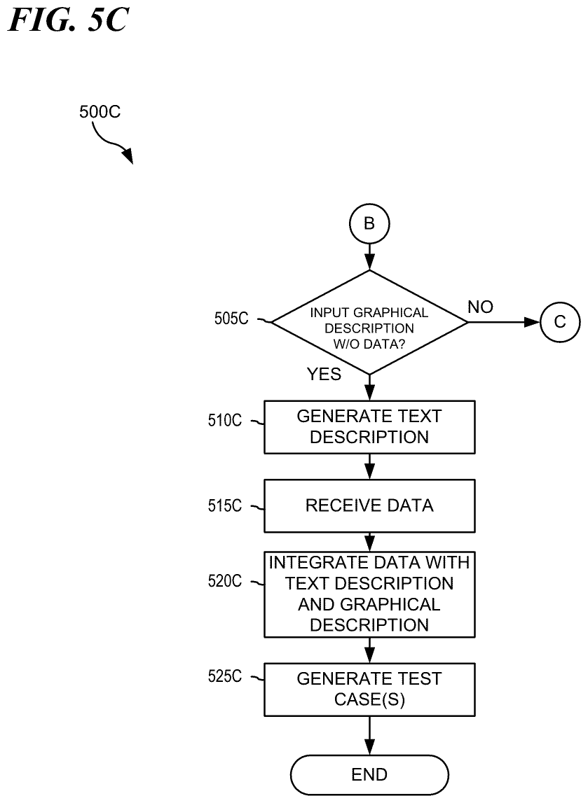

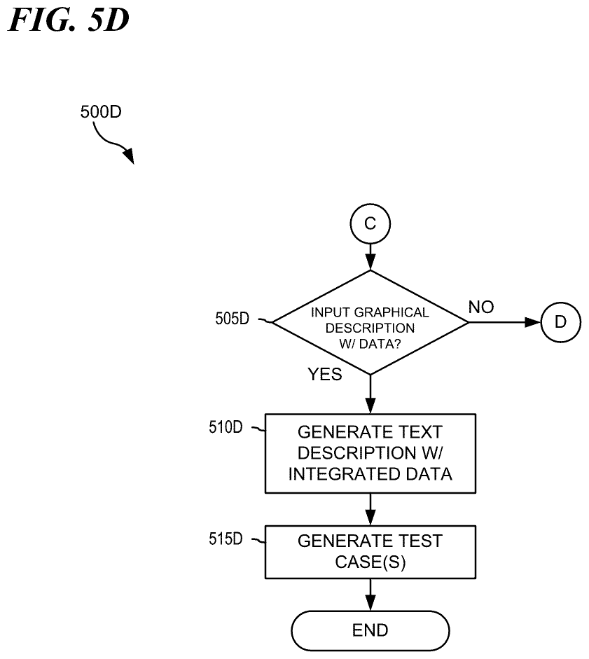

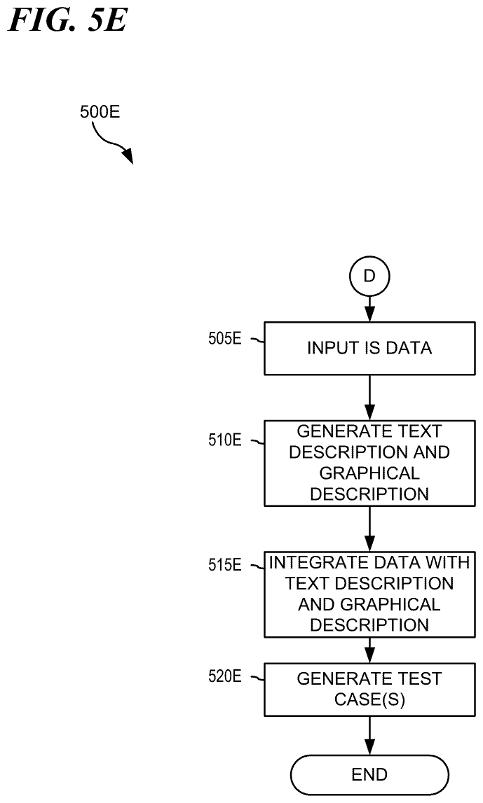

FIG. 3 illustrates a signal diagram according to an embodiment. While the illustrated signal diagram is generally oriented towards generating test cases using test templates as adapted by the arrangement in FIG. 2 a similar signal diagram can be adapted to the arrangement in FIG. 4 and the methods of FIGS. 5-7. Referring to FIG. 3, the generating circuitry 212 may generate one or more test templates (block 302) based on the software application model. The generating circuitry 212 may be comprised in a test generator or referred to as a test generator. The generated test template may comprise one or more values which may be adjusted or inputted by the user. Hence, in block 304 the obtaining circuitry 213 may obtain user input for one or more of said fields. Both the test template and its values may be transmitted to the determining circuitry 214 as utilizing one or more electrical signals (blocks 306 and 308). For example, an electrical signal may be used to carry the generated test template with the values within the arrangement 200.

The determining circuitry 214 may then (e.g., after receiving and/or in response to obtaining the test template and/or user input) verify the user input (block 310), for example, by performing one or more algorithms to verify that the data constraints are met. The user input, as shown as data input in FIG. 3: block 310, may be referred to as data selection at least in some embodiments. Data selection may refer to cases wherein the user provides the input by selecting certain value or values within a provided range. The selection may comprise selecting the value(s) amongst a plurality of predetermined values.

Once the data input or selection has been verified, the software application test(s), based on the test template, may be generated for later use or run immediately (e.g., in response to generating the verified tests). Verified test(s) may refer to software application tests that are determined to have values that meet the one or more constraints. For example, in one embodiment, a test template may be understood as a test that cannot be performed without providing/adjusting the data values of the test template. Hence, in some embodiments, the test template may also be referred to as an abstract test. Once the data values are provided, the concrete test(s) (i.e., software application test) may be generated based on the test template and run/executed. On the other hand, the test template may comprise initial data values that meet the one or more data value constraints. The arrangement 200 may generate such initial data values. Once the user adjusts one or more of said data values via the data input fields, the arrangement 200 may perform one or more checks to verify that the data input(s) (e.g., data selections) meet said one or more constraints. If not, the data values may be adjusted automatically without user's further input and/or inputted value(s) that does not meet the data value constraint(s) may be rejected. On the other hand, the arrangement 200 may prompt the user to verify that adjusting the data values is accepted.

Regarding circuitry 212 and step 302, the test generator may be configured to obtain the software application model and automatically analyze the model in order to generate the test template or templates. That is, the test generator, or some similar functionality or entity of the testing system, may analyze the obtained model. Analyzing may comprise analyzing and/or going through the model. The analyzing may comprise detecting one or more values and/or parameters in the model. The analyzing may further comprise detecting one or more data constraints for one or more detected values. The test generator may thus generate the test template(s) such that a test template comprises a data input field, for example, for each detected data value that is enabled to be modified, and one or more data constraints associated with the data input field.

Purely as an example, the test generator may find if-clauses from the model and determine values that lead to true and that lead to false scenarios. For example, for one if-clause, the test generator may determine, by analyzing the model (e.g., software code or pseudo representation of the code) values that make the if-clause be true and that make the if-clause be false. At least two different test templates may be generated: one for if-clause being true and another for if-clause being false. For example, a condition in an if-clause may be could be X<Y. Therefore, it is possible to generate more than one verified software application test from the same test template that makes said condition true (e.g., X=1, 2, 3, or 4; and Y=5) and more than one verified software application test from the same test template that makes said condition false (e.g., X=6 or 7; and Y=5). Accordingly, value constraints may be generated such that the true and false scenarios are obtainable. So, for example, for a test template for testing if-clause being false, the value constraints may be such that the if-clause should always return false. So, values which should lead to if-clause returning true should be rejected and/or adjusted. However, for example, for a test template for testing if-clause being true, the value constraints may be such that the if-clause should always return true. So, values which should lead to if-clause returning false should be rejected and/or adjusted.

FIG. 4 illustrates an exemplary system 400 for managing application tests according to an embodiment. As used herein, managing application tests includes generating, modifying, organizing, optimizing, and executing application tests. While system 400 can be configured to generate application tests in a variety of environments, system 400 is particularly well-suited for use in behavior driven development (BDD) environments. As illustrated, system 400 includes user interface (UI) 402, text description module 404, graphical description module 406, data management module 408, test case generation module 420, and output module 430. Broadly, a user operates UI 402, through user controls 410, to provide text description 412 and/or graphical description 414. Generally, text description 412 is a text or alphanumeric representation of an application, such as code written in Gherkin, for example. One of ordinary skill in the art will understand that text description 412 can be any suitable text description or natural language, including programming language or code. Generally, graphical description 414 is a graphical representation of an application, such as code written in BPML (Business Process Modeling Language), for example. One of ordinary skill in the art will understand that graphical description 414 can be any suitable graphical programming language.

In the illustrated embodiment, generally, system 400 maintains the text description 412 and graphical description 414 to be equivalent such that they are synchronized to ensure they represent the same application specification. As described in more detail below, if the user provides text description, system 400, by graphical description module 406, for example, generates or revises graphical description 414 to synchronize with the provided text description. Similarly, also as described in more detail below, if the user provides graphical description, system 400, by text description module 404, for example, generates or revises text description 412 to synchronize with the provided graphical description.

In the illustrated embodiment, system 400 includes data management module 408. Generally, data management module 408 is configured to receive, manage, and manipulate data 416. In one embodiment, UI 402 also includes an interface for a user to input data. One having ordinary skill in the art will understand that data can also be provided with text description and/or graphical description. In one embodiment, data 416 is data. Broadly, data includes text, numeric symbols, alphanumeric symbols, etc. One of ordinary skill in the art will understand that data includes a wide variety of input.

Broadly, system 400 manages test cases. In one embodiment, system 400 generates test cases, by test case generation module 420, for example, based on data, text description, and graphical description. In one embodiment, system 400 optimizes test cases. In one embodiment, system 400 presents a user interface for a user to see and edit test cases. In one embodiment, test cases are configured to test conformance of an application with the application specification. One having ordinary skill in the art will understand that test cases can be configured to test for various aspects of the target application, including performance, function, security, energy/power usage, for example, or any other desired software test cases.

In the illustrated embodiment, system 400, by output module 430, for example, prepares and transmits the test cases. Generally, testers will use the test cases to test the application. One having ordinary skill in the art will understand that the format of the output test cases can be configured to be usable by any product used in the SDLC (software development life-cycle). Similarly, APIs (Application Programming Interfaces) can be used to convert to whatever system the developers use. For example, the output can be configured to integrate into a test management system (TMS). In one embodiment, the TMS connects all of the information associated with testing (test cases, requirements, models, and test results) together into a database, which allows the QA (quality assurance) person to see the results.

In one embodiment, UI 402 includes views that allow a user to see the details of the text description 412, graphical description 414, and data 416. In one embodiment, user controls 410 also includes functionality to edit, revise, or manage, etc., text description 412, graphical description 414, and data 416. One having ordinary skill in the art will appreciate that the various users involved in software development, especially BDD, will find value in having this information available to the principal agents (tester, developer, business analyst) in being able to see what test failed, what test case caused the failure, and the specifics of the text/graphical representation of the application.

According to an embodiment, for example, a test template may comprise a unique identifier identifying the test template. The unique identifier may be transmitted from the arrangement 200 or system 400 to an external target (e.g., database), or within the arrangement 200 or system 400 from, for example, circuitry 212 to determining circuitry 214. Furthermore, the model (i.e., software application model) may be associated with a unique identifier. Hence, the model may be linked to the test templates for testing said model in database, for example. Moreover, a particular collection of data or text/graphical description may be associated with a unique identifier.

While not explicitly illustrated in FIG. 4, system 400 can also be configured to support the constraints, requirements and specifications as described with respect to FIGS. 2-3, above. Moreover, system 400 can be configured for a variety of operating environments.

In one embodiment, system 400 is a plug-in on a JIRA platform.

In one embodiment, text description module 404 includes a prompt that gives users a step prompt when they start an action in UI 402. For example, if a user is trying to define a behavioral step that already exists in the text description 412, text description module 404 can be configured to offer the existing version of that step in order to prevent similar, but differently described, steps from increasing the complexity of the target application.

In one embodiment, data 416 is uploaded from an Excel file. One having ordinary skill in the art will understand that a wide variety of suitable methods to input data are also available. In one embodiment, data 416 is stored in a database associated with a project configured to represent the application.

In one embodiment, UI 402 includes a database view and a user can select data from the database view to add to the text description 412 and/or graphical description 414. In one embodiment, data 416 added to text description 412 or graphical description 414 is copied into the text or graphical description itself. In one embodiment, data 416 added to text description 412 or graphical description 414 is referenced as a link to data 416.

In the illustrated embodiment, system 400 includes automation module 440 and automation script 442. Generally, automation script 442 is configured to provide automation instructions for automated testing of test cases generated by system 400. One of ordinary skill in the art will understand that there are a variety of automation protocols and automated test systems. In one embodiment, UI 402 allows a user to select a target automation protocol and/or test system to which automation script 442 is configured.

Additionally, in one embodiment automation module 440 is configured to synchronize automation script 442 with data 416, graphical description 414, and text description 412. In one embodiment, automation module 440 detects changes in one of text description 412, graphical description 414, and data 416 and modifies automation script 442 to synchronize with the detected changes. In one embodiment, output module 430 is configured to include automation script 442 in its output. In one embodiment, output module 430 includes as output generated test cases, text description 412, graphical description 414, data 416 and automation script 442.

FIGS. 5A-5E illustrate a flow diagram according to an embodiment. For example, in one embodiment, system 400 of FIG. 4 performs one or more of the steps illustrated in FIGS. 5A-5E. In the illustrated embodiment, the process starts begins at step 505A, in which the users identify the features they want the application to have. One of ordinary skill in the art will understand that the SDLC typically begins with human users, such as testers, developers, and business analysts, for example, discussing features sets, themes, and overall objectives for the target application. In BDD, this may include User Stories. For example, in step 505A, the users may decide that “application users should be able to log in to a protected view”.

In step 510A, input is received, such as, for example, by UI 402 of system 400. Broadly, system 400 takes various actions based on the received input. In one embodiment, system 400 includes an import function configured to receive input. In one embodiment, system 400 includes user interfaces through which a user can provide input.

In the context of software development, the embodiments disclosed herein are particularly well-suited to accommodate certain general features. For example, user input sometimes comprises input describing desired application features. Such input can be considered a model of the application system or a portion thereof and can be received using a programming language. The programming language can be text or graphical. Models in general, particularly models useful in computer-assisted design and development, may be computer readable. Models can be created manually by the user, they can be fully generated from various assets, or they can be created partially by hand and partially generated. For example, the user may generate the model of the software application. Said model may be a formalization of the software application specification, that is, the model may describe how the software application actually works or is intended to work. The model typically describes some aspect of the application to be tested, the testing environment, the expected usage of the application, the expected external behavior of the application (that is, they are formalizations of the software application specification), and/or test scenarios, etc.

In an embodiment, the model represents and/or describes a software application. In an embodiment, the model represents and/or describes a part of a software application. In an embodiment, the model represents and/or describes one or more functions of a software application.

In an embodiment, the model represents an environment of the software application. For example, the model may describe operation of one or more interfaces. For example, the software application may interface with another application or physical entity (e.g., port). Thus, the model may describe the operation of the external application and/or entity as experienced by the software application to be tested. In an embodiment, the model is automatically generated based on a system description and/or obtained software application (e.g., code of the application).

Referring again to FIG. 5A, in step 515A, a determination is made as to whether the received input is a text description without accompanying data. Text description input includes programming instructions that can optionally include data. Text description input without data includes, for example, the following code snippet: “WHEN the user enters a username THEN I ask for a password”. In one embodiment, system 400 analyzes received input and determines whether the received input is text description without data. In the event the input is not text description, or the input includes data, the process continues along the NO branch to target “A” of FIG. 5B. In the event the input is text description without data, the process continues along the YES branch to step 520A.

In step 520A, a graphical description is generated that is synchronized to the received text description such that both the text description and the graphical description represent the same application specification. In this particular case, the graphical description is created to match the application specification represented in the text description. In one embodiment, graphical description module 406 of system 400 performs this step.

In step 525, data is received. As described above, system 400 can be configured to receive data input in a variety of formats and protocols. For example, in one embodiment, data can be imported in bulk or entered manually. In one embodiment, data can be entered manually in either the text description or the graphical description.

In step 530A, received data is integrated into the text/graphical descriptions. In step 535A, test cases are generated and the process ends. In one embodiment, this step is performed by test case generation module 420. In one embodiment, at least one test case is generated based on the synchronized text description, the synchronized graphical description, and the data. In one embodiment, step 535A includes incorporating any additional coverage requirements or data adjustments. In one embodiment, step 535A optimizes one or more previously generated test cases based on based on the synchronized text description, the synchronized graphical description, and the data. Such optimization can include both generating new test cases and modifying existing test cases. In one embodiment, optimization results in new or modified test cases that are by some measurement an improvement or refinement of a previously generated test case or cases.

Generally, developing modern software requires testing at various stages of development. A computer-implemented method for generating verified software application tests is provided in U.S. Pat. No. 10,942,841, to which this application claims priority and which is hereby included by reference.

For example, in one embodiment, a method comprises acquiring a model representing functionality of a software application to be tested. The method automatically generates, based at least partly on the model, a test template for generating a plurality of verified software application tests. In one embodiment, the test template comprises a plurality of data input fields for data values and defines data value constraints for the data values. In one embodiment, the data value constraints for the data values are automatically determined based on the model. In one embodiment, the method obtains user data input regarding a data input field of the test template and determines whether said user data input defines a data value of the data input field according to the data value constraints. In one embodiment, in response to determining that said user data input does not define a data value according to the data value constraints, the method adjusts one or more data values of the test template such that said data value constraints are met. In one embodiment, at least one software application test meeting the data value constraints is generated based on the test template. In one embodiment, the method also comprises causing performing of said at least one software application test. In one embodiment, the method also comprises causing outputting results of said performed at least one software application test.

Alternatively or additionally, in one embodiment, in response to determining that said user data input does not define a data value according to the data value constraints, the method rejects said user data input. For example, if said data input does not define a data value according to the data value constraints regarding said data value, the input may be rejected. In case the user data input defines data value according to the data value constraints, the process may continue directly to generating at least one software test based on the template. Similarly, in one embodiment, the method also comprises evaluating more than one data input for compliance with the data value constraints.

While the above method focuses on automating test generation, the instant application describes novel advances in generating useful descriptions of the underlying system, among other things.

Moreover, some embodiments can also accommodate or be configured to support automated test-generation consistent with the application specification described in the text/graphical descriptions. Automatic or semi-automatic test generation methods may then comprise searching for interesting model locations that may represent testing goals, infer paths that lead to those interesting model locations, and export abstract test cases that each one encodes a one particular path thru model and a mechanism that allows one to further refine the test. The abstract test cases may refer to the test templates as described above. That is, abstract test may be an alternative term for a test template. The interesting model locations may be used define a finite number of abstract tests; for example, interesting model location may be if-clause in the software application defined by the model. Hence, a test template for each (or at least some) if-clauses is generated.

The test templates (or abstract tests or abstract test cases) so may be generated using at least three different approaches: graphical test scenario modeling which consists of modeling the test cases themselves in a graphical notation; environment/usage modeling which describe the expected environment of the application; or system modeling where the model represents the actual, desired behavior of the system itself. The first two approaches represent the point of view of the tester, not the system that is being tested. That is, these models describe how the application is used, and how the environment around the application operates. The models may include testing strategies, that is the input selection, and handcrafted output validators, or test oracles. A third approach may be a system model driven test generation approach which may automatically generate both test strategies and test oracles, possibly making the use of such an approach more straightforward and less error prone as the process of designing these may be totally omitted.

Referring now to FIG. 5B, the process begins at target “A”. In step 505B, a determination is made as to whether the received input is a text description with accompanying data. Text description input includes programming instructions that can optionally include data. Text description input with data includes, for example, the following code snippet: “WHEN the username is ‘John’ THEN the password is ‘sparky’”. In one embodiment, system 400 analyzes received input and determines whether the received input is text description with data. In the event the input is not text description, or the input does not includes data, the process continues along the NO branch to target “B” of FIG. 5C. In the event the input is text description with data, the process continues along the YES branch to step 510B.

In step 510B, a graphical description is generated that is synchronized to the received text description such that both the text description and the graphical description represent the same application specification. In this particular case, the graphical description is created to match the application specification represented in the text description. In one embodiment, graphical description module 406 of system 400 performs this step.

In step 515B, test cases are generated and the process ends. In one embodiment, this step is performed by test case generation module 420. In one embodiment, at least one test case is generated based on the synchronized text description, the synchronized graphical description, and the data. In one embodiment, step 515B includes incorporating any additional coverage requirements or data adjustments. In one embodiment, step 515B includes preparing test cases for incorporation of any additional coverage requirements or data adjustments by an external application.

Referring now to FIG. 5C, the process begins at target “B”. In step 505C, a determination is made as to whether the received input is a graphical description without accompanying data. Graphical description input includes graphical programming instructions that can optionally include data. Graphical description input without data includes, for example, a graphical representation of the following code snippet: “WHEN the user enters a username THEN I ask for a password”. In one embodiment, system 400 analyzes received input and determines whether the received input is graphical description without data. In the event the input is not graphical description, or the input includes data, the process continues along the NO branch to target “C” of FIG. 5D. In the event the input is graphical description without data, the process continues along the YES branch to step 510C.

In step 510C, a text description is generated that is synchronized to the received graphical description such that both the text description and the graphical description represent the same application specification. In this particular case, the text description is created to match the application specification represented in the graphical description. In one embodiment, text description module 404 of system 400 performs this step.

In step 515C, data is received. As described above, in one embodiment, system 400 can be configured to receive data input in a variety of formats and protocols. For example, in one embodiment, data can be imported in bulk or entered manually. In one embodiment, data can be entered manually in either the text description or the graphical description.

In step 520C, received data is integrated into the text/graphical descriptions. In step 525C, test cases are generated and the process ends. In one embodiment, this step is performed by test case generation module 420. In one embodiment, at least one test case is generated based on the synchronized text description, the synchronized graphical description, and the data. In one embodiment, step 525C includes incorporating any additional coverage requirements or data adjustments.

Referring now to FIG. 5D, the process begins at target “C”. In step 505D, a determination is made as to whether the received input is a graphical description with accompanying data. Graphical description input includes programming instructions that can optionally include data. Graphical description input with data includes, for example, a graphical representation of the following code snippet: “WHEN the username is ‘John’ THEN the password is ‘sparky’”. In one embodiment, system 400 analyzes received input and determines whether the received input is graphical description with data. In the event the input is not graphical description, or the input does not include data, the process continues along the NO branch to target “D” of FIG. 5E. In the event the input is graphical description with data, the process continues along the YES branch to step 510D.

In step 510D, a text description is generated that is synchronized to the received graphical description such that both the text description and the graphical description represent the same application specification. In this particular case, the text description is created to match the application specification represented in the graphical description. In one embodiment, text description module 404 of system 400 performs this step.

In step 515D, test cases are generated and the process ends. In one embodiment, this step is performed by test case generation module 420. In one embodiment, at least one test case is generated based on the synchronized text description, the synchronized graphical description, and the data. In one embodiment, step 515D includes incorporating any additional coverage requirements or data adjustments.

Referring now to FIG. 5E, the process begins at target “D”. In step 505E, received input is identified as data without accompanying text or graphical description. Data input without text or graphical descriptions can be configured in a varied of formats, such as a linked pair, for example: “{John, sparky}”.

In step 510E, a text description and graphical description are generated that are synchronized such that both the text description and the graphical description represent the same application specification. In one embodiment, text description module 404 and graphical description module 406 of system 400 perform this step.

In step 515E, received data is integrated into the text/graphical descriptions. In step 520E, test cases are generated and the process ends. In one embodiment, this step is performed by test case generation module 420. In one embodiment, at least one test case is generated based on the synchronized text description, the synchronized graphical description, and the data. In one embodiment, step 520E includes incorporating any additional coverage requirements or data adjustments.

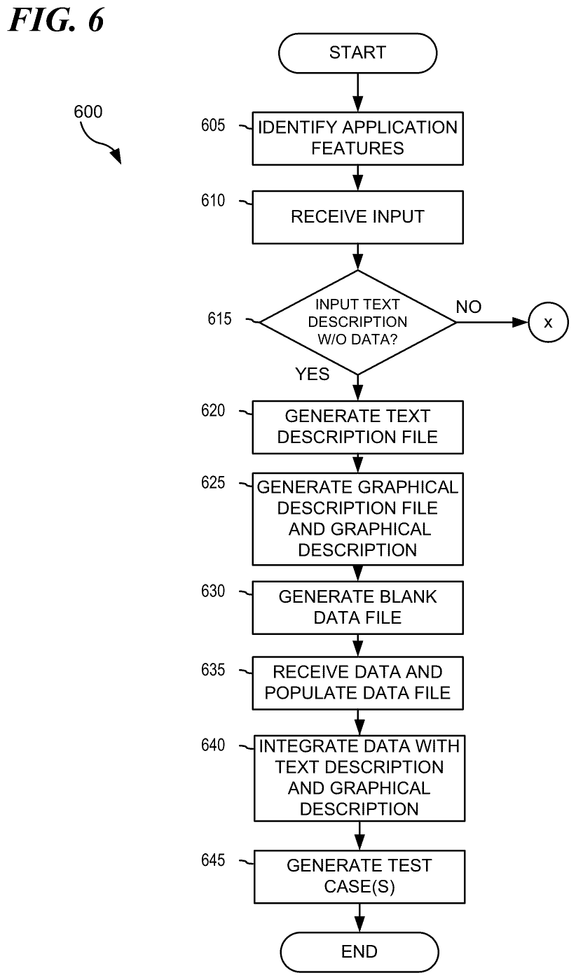

FIG. 6 illustrates a flow diagram according to an embodiment. In the illustrated embodiment, the process starts begins at step 605, in which the users identify the features they want the application to have. One of ordinary skill in the art will understand that the SDLC typically begins with human users, such as testers, developers, and business analysts, for example, discussing features sets, themes, and overall objectives for the target application. In BDD, this may include User Stories. For example, in step 605, the users may decide that “application users should be able to log in to a protected view”.

In step 610, input is received, such as, for example, by UI 402 of system 400. Broadly, system 400 takes various actions based on the received input. In one embodiment, system 400 includes an import function configured to receive input. In one embodiment, system 400 includes user interfaces through which a user can provide input.

In step 615, a determination is made as to whether the received input is a text description without accompanying data. Text description input includes programming instructions that can optionally include data. Text description input without data includes, for example, the following code snippet: “WHEN the user enters a username THEN I ask for a password”. In one embodiment, system 400 analyzes received input and determines whether the received input is text description without data. In the event the input is not text description, or the input includes data, the process continues along the NO branch to, for example, target “A” of FIG. 5B. In the event the input is text description without data, the process continues along the YES branch to step 620.

In step 620, a text description file is generated. In one embodiment, text description module 404 generates the text description file and populates the generated file with the received text description. In one embodiment, the text description is displayed to a user through UI 402.

In step 625, a graphical description file and a graphical description are generated that the graphical description populates the graphical description file and is synchronized to the received text description such that both the text description and the graphical description represent the same application specification. In this particular case, the graphical description is created to match the application specification represented in the text description. In one embodiment, graphical description module 406 of system 400 performs this step.

In step 630, a blank data file is generated. In one embodiment, this step is performed by data management module 408. In an alternate embodiment, this step is combined with step 635, below.

In step 635, data is received. As described above, system 400 can be configured to receive data input in a variety of formats and protocols. For example, in one embodiment, data can be imported in bulk or entered manually. In one embodiment, data can be entered manually in either the text description or the graphical description. In one embodiment, data management module 408 populates an existing data file with the received data. In one embodiment, data management module 408 creates a data file and populates the data file with the received data.

In step 640, received data is integrated into the text/graphical descriptions. In step 645, test cases are generated and the process ends. In one embodiment, this step is performed by test case generation module 420. In one embodiment, at least one test case is generated based on the synchronized text description, the synchronized graphical description, and the data. In one embodiment, step 645 includes incorporating any additional coverage requirements or data adjustments.

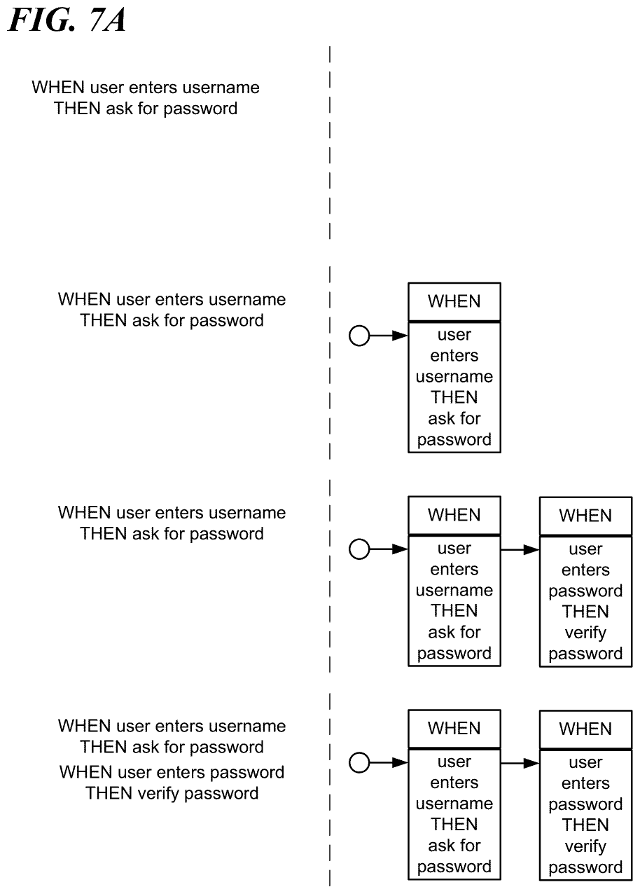

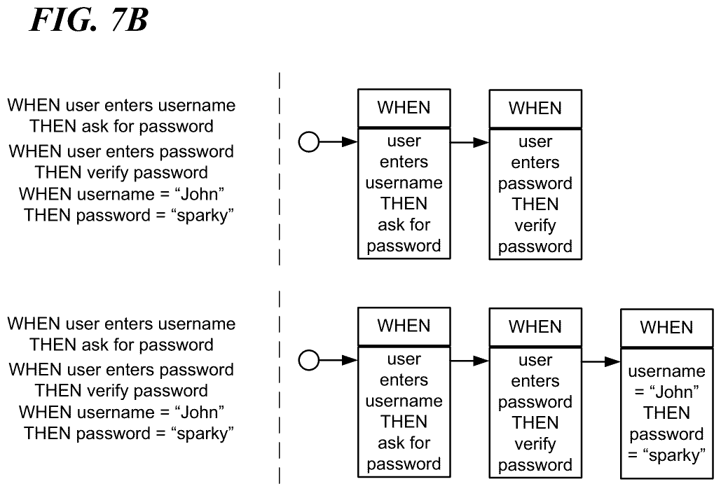

FIGS. 7A-7B illustrate a time line of synchronized generation according to an embodiment. The left side of FIGS. 7A-7B show text description and the right side show graphical description. In the top panel of FIG. 7A, a user has entered text description, such as through UI 402 in FIG. 4. In the second panel, graphical description has been automatically generated, such as by graphical description module 406, for example. In the third panel, a user has added some graphical description. In the fourth panel, additional text description has been automatically generated corresponding to the new graphical description.

In FIG. 7B, a user has manually entered some data and text description in the top panel. In the bottom panel, a graphical representation has been automatically generated corresponding to the new data and text description.

As shown, FIGS. 7A-7B illustrate the real-time synchronization process for all three aspects of the system model in one embodiment.

Benefits of the present solution are unambiguously clear for the skilled person. First of all, a need to rewrite or adjust code of the tests may be reduced or totally removed as the data values may be changed via the templates. Second of all, the tests may be verified so that the results of the test may be more reliable. For example, let us consider a case in which a hard-coded test is re-coded. The tester may perform this by hand and possibly using some sort of specification as a back-up. However, there may be no verification that the re-coded test is validly Hence, the hard-coded test needs to be further somehow amended. validated/verified. However, in the present solution the data value constraints may be generated once, which are determined and/or verified to be made according to the needed test, that is, if data values fulfill said data value constraints, the generated test may be verified. So, when generating new tests based on the test template, there may be no need to further validate the data values as the test template's data value constraint take this already into account. So, the presented solution may enable adoption in a process where test design is divided in to separate test flow and test data design; may enable an integration with combinatorial test data and other testing tools by frontending the tool fully circumventing the need to create a separate “model” for the tool by simply serializing the test template produced by this approach in the format expected by the testing tool; may provide answers to the question where users expect to have more control over the data selection process, enable means of experimenting with different data values, and enables a way to easily utilize expert/domain knowledge in test design; may enable the use of production data by instantiating the test templates fully automatically by the production data; and/or may enable automatic validation of the data consistency preventing creation of SW application tests that are internally inconsistent in terms of the test flow (i.e., the control flow/path to be tested) and the data.

As used in this application, the term ‘circuitry’ refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory (ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware.

In an embodiment, at least some of the processes described in connection with FIGS. 2-3, 5A-E, and 6 may be carried out by an apparatus comprising corresponding means for carrying out at least some of the described processes. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry. In an embodiment, the at least one processor, the memory, and the computer program code form processing means or comprises one or more computer program code portions for carrying out one or more operations according to any one of the embodiments of FIGS. 2-3, 5A-E, and 6 or operations thereof.

According to yet another embodiment, the apparatus carrying out the embodiments comprises a circuitry including at least one processor and at least one memory including computer program code. When activated, the circuitry causes the apparatus to perform at least some of the functionalities according to any one of the embodiments of FIGS. 2-3, 5A-E, and 6, or operations thereof.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g., procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program or portions thereof.

Embodiments of the methods described in connection with FIGS. 2-3, 5A-E, and 6 may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium, for example. Coding of software for carrying out the embodiments as shown and described is well within the scope of a person of ordinary skill in the art. In an embodiment, a computer-readable medium comprises said computer program.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. A computer-implemented method for generating software application tests, the method comprising:
receiving application requirements input describing at least one desired application feature, the application requirements input comprising at least one of a model and a text description;
generating a synchronized model based on received text description and generating a synchronized text description based on a received model, wherein the synchronized model and synchronized text description both describe the same at least one desired application feature;
receiving test data;
integrating received test data with the synchronized model and the synchronized text description; and
generating at least one test based on the synchronized model, the synchronized text description, and the integrated test data.

2. The method of claim 1, further comprising configuring a plug-in running on a JIRA platform to perform the steps of the method.

3. The method of claim 1, further comprising presenting, to a user, a synchronized model based on a received text description.

4. The method of claim 1, further comprising presenting, to a user, a synchronized text description based on a received model.

5. The method of claim 1, further comprising presenting to a user, in response to received text description, at least one similar text description from a list of behavioral step text descriptions.

6. The method of claim 1, wherein the test data is received as an Excel file.

7. The method of claim 1, wherein the test data is stored in a database associated with a project configured to represent the application.

8. The method of claim 1, wherein the test data is received as part of a text description or graphical description.

9. The method of claim 1, further comprising generating automation instructions for automated testing of test cases.

10. The method of claim 9, further comprising synchronizing automation instructions with the synchronized model in response to changes to the synchronized model.

11. A non-transitory computer readable medium comprising:
first instructions stored on the non-transitory computer readable medium for, when utilized by one or more processors:
receiving application requirements input describing at least one desired application feature, the application requirements input comprising at least one of a model and a text description;
generating a synchronized model based on received text description and generating a synchronized text description based on a received model, wherein the synchronized model and synchronized text description both describe the same at least one desired application feature;
receiving test data;
integrating received test data with the synchronized model and the synchronized text description; and
generating at least one test based on the synchronized model, the synchronized text description, and the integrated test data.

12. The non-transitory computer readable medium of claim 1, further comprising instructions for configuring a plug-in running on a JIRA platform to perform the steps of the method.

13. The non-transitory computer readable medium of claim 1, further comprising instructions for presenting, to a user, a synchronized model based on a received text description.

14. The non-transitory computer readable medium of claim 1, further comprising instructions for presenting, to a user, a synchronized text description based on a received model.

15. The non-transitory computer readable medium of claim 1, further comprising instructions for presenting to a user, in response to received text description, at least one similar text description from a list of behavioral step text descriptions.

16. The non-transitory computer readable medium of claim 1, wherein the test data is received as an Excel file.

17. The non-transitory computer readable medium of claim 1, wherein the test data is stored in a database associated with a project configured to represent the application.

18. The non-transitory computer readable medium of claim 1, wherein the test data is received as part of a text description or graphical description.

19. The non-transitory computer readable medium of claim 1, further comprising generating automation instructions for automated testing of test cases.

20. The non-transitory computer readable medium of claim 9, further comprising instructions for synchronizing automation instructions with the synchronized model in response to changes to the synchronized model.
